(19) United States
(12) Patent Application Publication
(10) Pub. No.: US 2023/0019310 A1
(43) Pub. Date: Jan. 19, 2023

(54) Musical Instrument Microphone Holder

(71) Applicant: Marta Cesar, Miami, FL (US)

(72) Inventor: Marta Cesar, Miami, FL (US)

(21) Appl. No.: 17/867,714

(22) Filed: Jul. 19, 2022

Related U.S. Application Data
(60) Provisional application No. 63/223,213, filed on Jul. 19, 2021.

(51) Int. Cl. H04R 1/08

(52) U.S. Cl. CPC H04R 1/083

(57) ABSTRACT

The present invention relates generally to the field of accessories for musical instruments and specifically to a guitar microphone holder. The holder has a body, a microphone mount attached to a central portion of the body and two arms that extend downwardly from the central portion. The body and arms of the device further resemble one or more musical notes. The holder is flexible, such that it applies a compression force that retains the device on the musical instrument.

### CROSS-REFERENCE TO RELATED APPLICATION

The present application claims priority to, and the benefit of, U.S. Provisional Application No. 63/223,213, which was filed on Jul. 19, 2021, and is incorporated herein by reference in its entirety.

### FIELD OF THE INVENTION

The present invention relates generally to the field of accessories for musical instruments. More specifically, the present invention relates to a guitar microphone holder that is comprised of a body, a microphone holder mount attached to the body, and a microphone holder. The body of the device further can be any shape and is flexible or semi-flexible with a soft padding so that it can be positioned to contact or engage the front and rear surfaces of a guitar to create a compression force to help retain the device in position on the guitar. The device also includes a microphone mount and a microphone holder that supports and retains a microphone. In this manner, the device can be applied to any guitar, banjo, bass or similar instrument such that a musician can move freely with the guitar or instrument while on stage and still have convenient access to a microphone at all times. Accordingly, the present disclosure makes specific reference thereto. Nonetheless, it is to be appreciated that aspects of the present invention are also equally applicable to other like applications, devices and methods of manufacture.

### BACKGROUND OF THE INVENTION

Many musicians perform while simultaneously singing and playing the guitar. However, since playing a guitar normally requires two hands, a microphone must be placed on a microphone stand or other support near the musician at a fixed position on a stage. Therefore, if a musician desires to walk or move around a stage area while playing the guitar or other instrument, they must return to the microphone stand to sing which is undesirable for musicians who wish to actively move around a stage while performing. In addition, uneven stages can provide suboptimal surfaces for microphones stands that may cause a stand to sway and even fall over during a performance. Furthermore, head-worn microphones or headsets are unsightly and often must be secured to the face of a musician with tape while performing, which is uncomfortable and undesirable.

Therefore, there exists a long-felt need in the art for an improved microphone-holding device. There also exists a long-felt need in the art for a microphone holder or support that is not bound to a fixed point on a stage such that a musician may move around a stage without restraint during a performance, or can be used seated in his/her home, recording studio, or other place, as preferred. Further, there exists a long-felt need in the art for a microphone holder that can attach to a guitar, banjo, bass or other instrument in a manner that does not require the holder and a microphone to be held by a user while performing. In addition, there exists a long-felt need in the art for a guitar microphone holder that eliminates the need for a musician to use a traditional microphone stand while playing guitar.

The subject matter disclosed and claimed herein, in one embodiment thereof, comprises a guitar, banjo, bass or other instrument microphone holder device. The device includes a body, a microphone holder mount attached to the body and a microphone holder. The body of the device has any shape, and is flexible or semi-flexible such that it can be positioned to contact or engage the front and rear surfaces of the instrument to create a compression force that retains or holds the device on the neck or body of the instrument. The device also includes a microphone mount and a microphone holder that retains a microphone or other voice-amplifying device. In this manner, the device can be applied to any guitar or similar instrument, such that a musician can move freely around a performance area with the instrument while on stage and still have access to a microphone at all times.

In this manner, the guitar microphone holder device of the present invention accomplishes all of the forgoing objectives and provides an improved means to perform with a microphone. Further, the device is not bound to a fixed point on a stage such that it allows a musician to move without restraint during a performance. In addition, the device can be universally attached to any guitar, banjo, bass or similar type of instrument in a manner that does not require the microphone holder to be held by a user while performing. The device also eliminates the need for a musician to use a traditional microphone stand while performing and playing a guitar or similar instrument.

### SUMMARY OF THE INVENTION

The following presents a simplified summary in order to provide a basic understanding of some aspects of the disclosed innovation. This summary is not an extensive overview, and it is not intended to identify key or critical elements or to delineate the scope thereof. Its sole purpose is to present some general concepts in a simplified form as a prelude to the more detailed description that is presented later.

The subject matter disclosed and claimed herein, in one embodiment thereof, comprises a musical instrument microphone holder device that allows a microphone to be secured onto a portion of the musical instrument, such that a user can move freely with the microphone and instrument while performing on a stage. The device is comprised of a body, a microphone holder mount attached to the body and a microphone holder. In differing embodiments, the body may have the appearance of a plurality of differing types of shapes. The body may also be made of a plurality of natural tone woods or other materials that may be commonly used for making such string-based instruments. However, the body is preferably made of a flexible or semi-flexible plastic material, or metal. In addition, any surface of the body may be comprised of a plurality of indicia such as patterns, logos, emblems, images, symbols, designs, letters, words, characters, animals, advertisements, brands, etc., that may or may not be music or musician-related. As used herein, instrument refers generally to an instrument having a body and a neck, such as a guitar, violin, banjo, mandolin, bass, ukulele, fiddle, sitar and other folk or traditional instruments.

The body also has a fixedly or removably-attached microphone holder mount that is comprised of a hinge that attaches a generally U-shaped microphone holder to the mount. The holder mount may be adjustable to accommodate different sizes or types of instruments. The microphone holder may be removably or fixedly attached to the hinge in differing embodiments and may receive a microphone. Both the mount and holder are preferably made from a rigid plastic. The mount and holder are also preferably rotatable up to three-hundred and sixty degrees, as well as being able to be angled upwards and downwards up to one-hundred and eighty degrees to allow for microphone adjustment. In addition, one embodiment of the device may have a flexible gooseneck arm that attaches to the hinge and to the microphone holder. In this manner, the arm can be easily repositioned or moved to place a microphone or other amplifying device in a desired position while a user is performing with the instrument and microphone using the device.

The device can further be positioned on the instrument by bending the body such that the left portion of the body contacts or engages with the front surface of the instrument, and the right portion of the body contacts or engages with the rear surface of the instrument. In this manner, the flexible or semi-flexile body creates a compressive force on each surface of the instrument in order to retain the device on the instrument. To ensure the body does not damage the surfaces of the instrument, the body may further include fixedly or removably-attached padding sections or pieces of material. The padding is preferably soft, lightweight and made of a scratch-resistant material. The body may also have a fixedly or removably-attached instrument pick holder that can store a plurality of instrument picks, as well as other items such as strings that may be needed by a performer during a show. The holder is a spring-loaded pick or accessory holder.

Accordingly, the instrument microphone holder device of the present invention is particularly advantageous as it allows a musician to move freely about the area with a microphone or other amplifying device during a performance. Further, the device can universally attach to any instrument having a body in a manner that does not require a microphone to be held by a user while performing. Therefore, the device eliminates the need for a musician to use a traditional microphone stand while playing an instrument such as a guitar or bass and singing.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a front perspective view of one potential embodiment of an instrument microphone holder device of the present invention in accordance with the disclosed architecture;

FIG. 2 illustrates a front perspective view of one potential embodiment of an instrument microphone holder device of the present invention attached to an instrument such as a guitar in accordance with the disclosed architecture; and

FIG. 3 illustrates a rear perspective view of one potential embodiment of an instrument microphone holder device of the present invention attached to an instrument such as a guitar in accordance with the disclosed architecture.

### DETAILED DESCRIPTION OF THE INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for an improved microphone, holding or supporting device. There also exists a long-felt need in the art for a microphone or voice amplification holder that is not bound to a fixed point on a stage or performance area, such that the holder allows a musician to move without restraint during a performance, while using an instrument such as a guitar, violin, banjo, mandolin, bass, ukulele, fiddle, sitar or other instruments and singing. Further, there exists a long-felt need in the art for a microphone holder that can attach or be secured to an instrument in a manner that does not require a microphone to be held by a user while performing. The microphone holder may also include auxiliary straps to prevent movement in the transverse or longitudinal direction. In addition, there exists a long-felt need in the art for an instrument microphone holder that eliminates the need for a musician to use a traditional microphone stand or headset while playing the instrument and signing.

The present invention, in one exemplary embodiment, is comprised of an instrument microphone holder device that allows a microphone to be secured onto an instrument such as a guitar, violin, banjo, mandolin, bass, ukulele, fiddle, sitar or other folk or traditional stringed instrument, such that the artist can move freely with the microphone and guitar while performing on a stage. The device has a body, a microphone holder mount attached to the body and a microphone holder. The holder include a pair of opposing arms on each side of a central body portion. Each of the opposing arms has a distal end with an enlarged area for gripping onto the body of the instrument. In differing embodiments, the body may have different shapes. The body may also be made of a plurality of natural tone woods or other materials that may be commonly used for making stringed instruments, but is preferably made of a flexible or semi-flexible plastic material, or metal. In addition, any surface of the body may have a plurality of indicia such as patterns, logos, emblems, images, symbols, designs, letters, words, characters, animals, advertisements, brands, etc., that may or may not be music or musician-related.

Further, the body has a fixedly or removably-attached microphone holder mount that includes a hinge that attaches a generally U-shaped microphone holder to the mount. The U-shaped holder having a central body portion and two arms extending downwardly from the central body portion to engage opposing sides of the body of the instrument. Each of the arms has an enlarged end portion to facilitate gripping the body of the instrument. The microphone holder may be removably or fixedly-attached to the hinge in differing embodiments, and may receive a microphone. Both the mount and holder are preferably manufactured from a rigid plastic and may including graphic or aesthetic features to blend more readily with the instrument to which the holder is connected. The mount and holder are also preferably rotatable up to three-hundred and sixty degrees, as well as being able to be angled upwards and downwards up to one-hundred and eighty degrees to allow for microphone adjustment. Furthermore, in one embodiment the device may have a flexible “gooseneck” arm that attaches to the hinge and to the microphone holder, so that the arm can be easily repositioned to place a microphone in a desired position while the artist is performing with the instrument and microphone using the device.

The position of the device on the body of the instrument can be flexed or bent such that the left portion of the body contacts the front surface of instrument body, and the right portion of the body contacts the rear surface of the instrument body. In this manner, the flexible or semi-flexile body creates a compressive force ranging from 30 mmHG to 100 mmHG on each surface of the guitar in order to retain the device on the instrument without damaging the body of the instrument. To ensure the holder does not damage the surfaces of the instrument, the holder may further have fixedly or removably-attached padding sections that are preferably soft, lightweight and made of a scratch-resistant material. The holder may also have a fixedly or removably attached accessory holder for holding guitar picks, strings or other items that may be needed by the artist and that can store a plurality of different items.

Accordingly, the guitar microphone holder device of the present invention is particularly advantageous as it allows a musician to move freely about an area with a microphone during a performance. Further, the device can universally attach to any instrument in a manner that does not require a microphone to be held by the artist while performing. Therefore, the device eliminates the need for a musician to use a traditional microphone stand while playing guitar and singing.

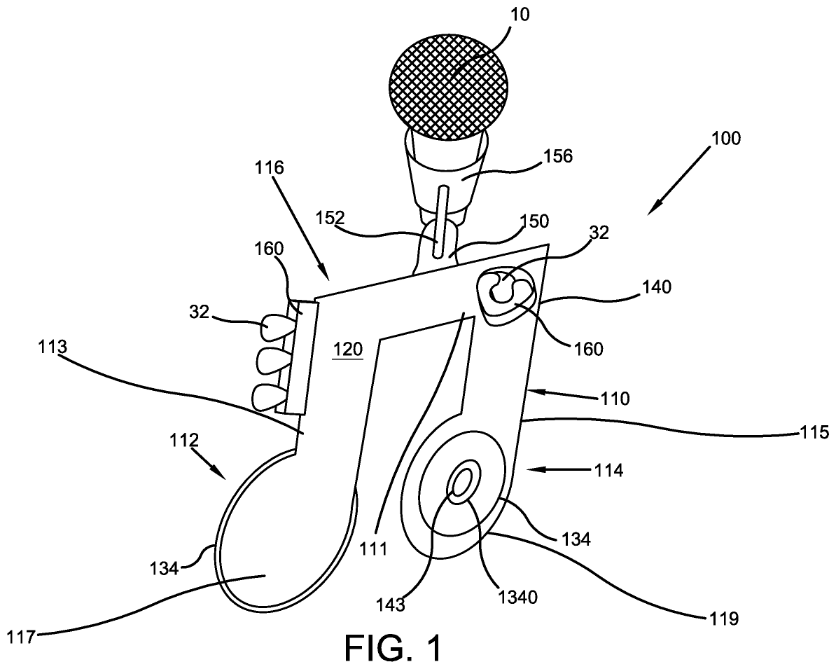

Referring initially to the drawings, FIG. 1 illustrates a front perspective view of one potential embodiment of an instrument microphone holder device 100 of the present invention in accordance with the disclosed structure. The device 100 has a body 110 that includes a central portion 111 and two arms 113 and 115 extending generally downwardly from the central portion. Each of the arms 113 and 115 has an enlarged end 117 and 119 for providing a clamping or compression force onto the body of the musical instrument. The enlarged ends may also include a suction cup 143 to aid in securing and holding the mounting device 100 to the musical instrument. The central portion has a length that is generally equivalent to the width of a musical instrument to which it is to be attached. A microphone holder mount 150 is attached to the body 110 and a microphone holder 156. In differing embodiments, the body 110 may have a plurality of shapes that might include or not at least one or more musical symbols, notes, chords or combinations thereof, such as but not limited to: a whole note, a half note, a quarter note, an eighth note, a sixteenth note, a thirty-second note, a slanted beamed eighth note, a beamed eighth note, a slanted beamed sixteenth note, a beamed sixteenth note, a slanted beamed thirty-second note, a beamed thirty-second note, a sharp, a flat, a treble clef, a bass clef, etc. Further, the body 110 of the holder may be made of a plurality of materials such as wood (especially tone woods used for manufacturing guitars) or metal, but is preferably made of a flexible or semi-flexible plastic such as but not limited to: acrylic, polycarbonate, polyethylene, thermoplastic, acrylonitrile butadiene styrene, low density polyethylene, medium density polyethylene, high density polyethylene, polyethylene terephthalate, polyvinyl chloride, polystyrene, polylactic acid, acetal, nylon, fiberglass, etc. In addition, the body of the holder 110 may be transparent, semi-transparent or opaque in differing embodiments. Furthermore, the top surface 120 and side surfaces 140 of the body 110 may be comprised of any number of indicia 122 in the form of patterns, logos, emblems, images, symbols, designs, letters, words, characters, animals, advertisements, brands, etc., that may or may not be music or musician-related.

In the preferred embodiment of the device 100 shown in FIGS. 1,2, and 3, the body 110 is shaped like a slanted beamed eighth note. The top portion 116 of the body 110 is further comprised of a fixedly or removably-attached microphone holder mount 150. The mount 150 includes a hinge 152 that attaches a generally U-shaped microphone holder 156 to the mount 150. The holder 156 may be removably or fixedly-attached to the hinge 152 in differing embodiments, and may receive a microphone 10 or other voice-amplifying device. Both the mount 150 and holder 156 are preferably manufactured from a rigid plastic, but may also be comprised of metal in differing embodiments. Further, the mount 150 and holder 156 are preferably rotatable up to three-hundred and sixty degrees, as well as being able to be angled upwards and downwards up to one-hundred and eighty degrees to allow for microphone 10 adjustment.

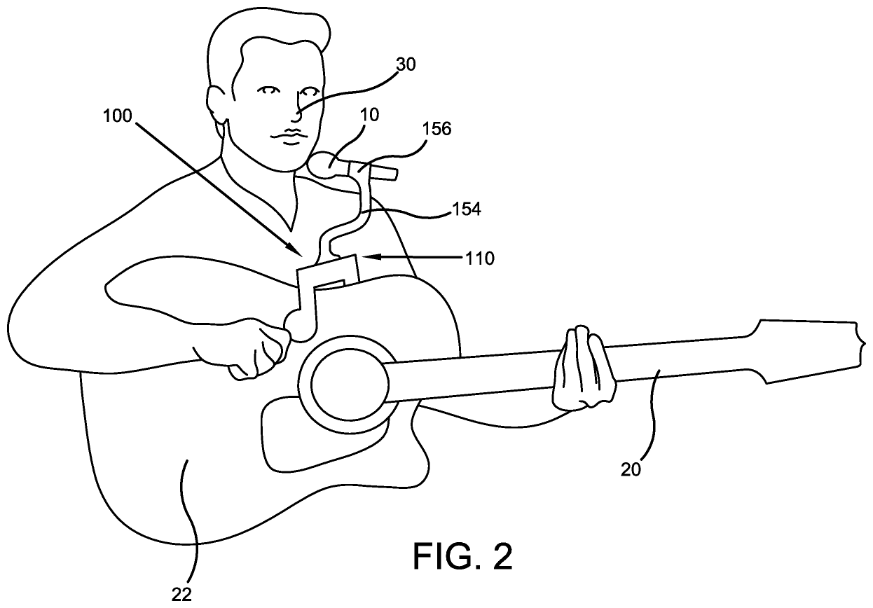

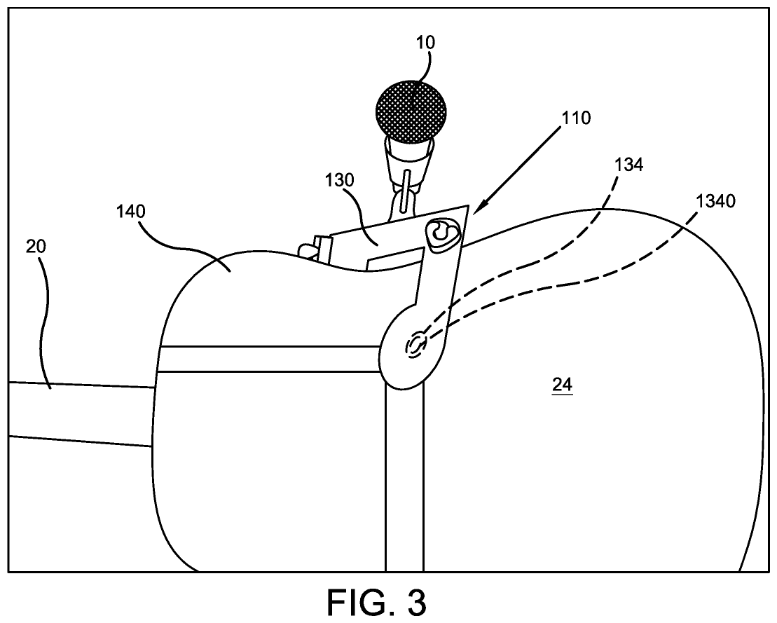

FIG. 2 illustrates a front perspective view of one potential embodiment of a musical instrument, such as a guitar, microphone holder 100 of the present invention attached to the instrument 20 in accordance with the disclosed specification. To attach the device 100 to a musical instrument such as an acoustic or electric guitar 20, the left portion 112 of the body 110 is placed in contact with the front surface 22 of a guitar 20 and the right portion 114 is placed in contact with the rear surface 24 of a guitar (as best seen in FIG. 3). In this position, the flexible or semi-flexile body of the microphone holder 110 creates a compressive force on each surface 22, 24 of the musical instrument 20 in order to retain the device 100 on the instrument 20. The compressive force may range from 30 mmHg to 100 mmHg or the pressure needed to remain in place, and may be adjustable by inserting compressible pads of material between the body of the musical instrument and the holder. Further, in order to not scratch the finish of the guitar, the bottom surface 130 of the left portion 112 of the body 110 and the top surface 120 of the right portion 114 of the body may be comprised of fixedly-attached or removably-attached padding sections 134 (as seen in FIG. 1). The padding 134 is preferably made of a soft, lightweight, scratch resistant compressible material that does not scratch or damage the musical instrument 20 surfaces 22, 24. In one embodiment, the padding 134 may further have a peelable adhesive backing to allow it to be fixedly-attached to the body 110, but removed as needed. In one embodiment, each section of padding 134 may further be comprised of a fixedly or removably-attached suction cup 1340 and 143 that can create a suction force between the device 100 and the musical instrument 20 surfaces 22, 24 to retain the device 100 onto a guitar 20. As also shown in FIG. 2, one embodiment of the device 100 may have a flexible gooseneck arm 154 that attaches to the hinge 152 and to the microphone holder 156. In this manner, the arm 154 can be easily repositioned to the desired orientation to place a microphone 10 in a desired spot while a user 30 is performing with the musical instrument 20 and microphone 10 using the device 100.

Any surface 120, 130, 140 of the holder body 110 may further include an accessory holder 160, such as picks, extra strings or anything else the artist may find useful. The holder 160 may be removably or fixedly-attached to any surface 120, 130, 140 and can store a plurality of guitar picks 32 or other items. In the preferred embodiment, the holder 160 has the design of a traditional spring-loaded guitar pick holder known in the art. However, in a differing embodiment the pick holder 160 may be a microphone stand-style pick holder known in the art that can accommodate a plurality of picks 32 in a vertical fashion. Both embodiments of the holder 160 are further shown in FIG. 1.

FIG. 3 shows the back of the musical instrument 24 with the microphone holder 110 held on the musical instrument by compression forces. FIG. 3 also includes other straps 141 which may prevent shifting in the longitudinal or transverse directions when the holder is mounted on the instrument.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “musical instrument microphone holder device”, “guitar microphone holder”, and “device”, are interchangeable and refer to the microphone holder device 100 of the present invention for use with a musical instrument.

Notwithstanding the forgoing, the guitar microphone holder device 100 of the present invention and its various components can be of any suitable size and configuration as is known in the art without affecting the overall concept of the invention, provided that they accomplish the above-stated objectives. One of ordinary skill in the art will appreciate that the size, configuration and material of the guitar microphone holder device 100 as shown in the FIGS. are for illustrative purposes only, and that many other sizes and shapes of the guitar microphone holder device 100 are well within the scope of the present disclosure. Although the dimensions of the guitar microphone holder device 100 are important design parameters for user convenience, the guitar microphone holder device 100 may be of any size, shape and/or configuration that ensures optimal performance during use and/or that suits the user's needs and/or preferences. The device 100 can be used either sitting or standing, depending on the preference of the musician.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A microphone holder for a musical instrument, the microphone holder comprising:
a central portion with first and second arms extending generally downwardly from the central portion, wherein each of the first and second arms comprise an enlarged area at a first end, and further wherein the central portion comprises a length that is equal to a width of a body of the musical instrument; and
a mount for a microphone attached to the central portion, wherein the mount is adjustable with respect to the central portion.

2. The microphone holder as recited in claim 1, wherein at least one of the enlarged areas of the first and second arms comprises a compressible pad.

3. The microphone holder as recited in claim 1, wherein the first and second arms apply a compressive force to hold the microphone holder in a desired position on the musical instrument.

4. The microphone holder as recited in claim 1, wherein the compressive force ranges from between 30 mmHg to about 100 mmHg.

5. The microphone holder as recited in claim 1, wherein a combination of the central portion, the first and second arms and the enlarged areas resemble a musical note.

6. The microphone holder as recited in claim 1, wherein the mount further comprises a gooseneck having a holder for the microphone.

7. The microphone holder as recited in claim 1, wherein the mount is connected to the central portion by a hinge.

8. The microphone holder as recited in claim 1, wherein the central body portion comprises an accessory holder.

9. The microphone holder as recited in claim 1, wherein the musical instrument is one of a guitar, a violin, a banjo, a mandolin, a bass, a ukulele, a fiddle or a sitar.

10. The microphone holder as recited in claim 8, wherein the accessory holder holds at least one pick and strings.

11. A musical instrument and microphone holder assembly comprising:
a musical instrument selected from a group consisting of a guitar, a violin, a banjo, a mandolin, a bass, a ukulele, a fiddle or a sitar, wherein the musical instrument is comprised of a body having a width; and
a microphone holder assembly comprised of a central portion having a length substantially equal to the width of the body of the musical instrument, wherein the central portion is comprised of a pair of arms extending generally downwardly and ach having an enlarged end portion, and further wherein the pair of arms provide a compression force to the body of the musical instrument.

12. The musical instrument and microphone holder assembly as recited in claim 11, wherein the compression force ranges from between 30 mmHg to about 100 mmHg.

13. The musical instrument and microphone holder assembly as recited in claim 12, wherein the enlarged end portions are comprised of a compressible pad or a suction cup.

14. The musical instrument and microphone holder assembly as recited in claim 13, wherein the central portion comprises a microphone mount.

15. The musical instrument and microphone holder assembly as recited in claim 14, wherein the microphone mount is rotatable up to three-hundred and sixty degrees, and movable upwards and downwards up to one-hundred and eighty degrees.

16. The musical instrument and microphone holder assembly as recited in claim 15, wherein the microphone mount comprises a flexible gooseneck.

17. The musical instrument and microphone holder assembly as recited in claim 16, wherein the central portion further comprises an accessory holder.

18. The musical instrument and microphone holder assembly as recited in claim 17, wherein the accessory holder holds at least one pick and a string.

19. A microphone holder and guitar combination comprising;
a guitar having a body having a width;
a microphone holder having a central portion with a hinged microphone mount and first and second arms extending generally downwardly from the central portion;
each of the first and second arms has an enlarged area at the ends of the arms and the enlarged area has a compressible foam and a suction cup;
the first and second arms apply a compression force to the body of the guitar; and
the hinged microphone mount is rotatable up to three-hundred and sixty degrees, and movable upwards and downwards up to one-hundred and eighty degrees.

20. The microphone holder and guitar combination as recited in claim 19, wherein the compression force ranges from between 30 mmHg to about 100 mmHg or the amount needed.
